(19) United States
(12) Patent Application Publication
(10) Pub. No.: US 2017/0172189 A1
(43) Pub. Date: Jun. 22, 2017

(54) Preservation of Native Fruit and/or Vegetable Coloring in Cooked Food Products

(71) Applicant: Frito-Lay North America, Inc., Plano, TX (US)

(72) Inventors: Ajay Rajeshwar Bhaskar, Allen, TX (US); Sathya Kalambur, Lewisville, TX (US); David Philip Stein, Frisco, TX (US)

(21) Appl. No.: 14/978,993

(22) Filed: Dec. 22, 2015

(51) Int. Cl. A21D 2/36; A21D 13/00

(52) U.S. Cl. CPC A23L 7/13; A21D 2/36; A21D 13/0074

(57) ABSTRACT

A shelf-stable snack product having visibly impactful vegetable inclusions, a composite dough for forming the shelf-stable snack product, and method of manufacture is disclosed herein. The shelf-stable snack product includes masa and a fresh vegetable ingredient, and a final moisture content in the range of about 1.7-2.5 weight percent. Additionally, the shelf-stable snack product has an l-value no less than a corresponding l-value of a plain version of the shelf-stable snack product lacking the vegetable inclusions.

### BACKGROUND OF THE INVENTION

Technical Field

The present invention relates generally to a shelf-stable snack product with fruit and/or vegetable inclusions. More particularly, the disclosure herein provides for a snack product having green fruit and/or vegetable inclusions and a corresponding method of preparation that preserves the desirable visual characteristics of the snack product and fruit and/or vegetable inclusions throughout the cooking process.

Background

“Shelf-stable” is a term that describes a food item that may be stored at ambient conditions for a useful length of time without the need for refrigeration, and while maintaining all desirable organoleptic properties. Examples of processes that can be used to create shelf-stable food products include irradiation, pasteurization, hydrogenation, and dehydration. Examples of food products to which these processes may be applied include snack products, such as potato chips and tortilla chips. Shelf-stable snack products protect against waste by extending the amount of time that manufacturers have to package the snacks, ship to a point of sale, and store until a consumer has an opportunity to purchase the product for consumption. From a consumer's perspective, shelf-stable snack products may be purchased and eaten at their leisure without the fear that the product will go stale or spoil.

The addition of vegetables, or their flavors, into shelf-stable snack food products is typically by way of topical application using seasoning or adhering steps. These topical application steps usually follow dehydration processes. Incorporating visibly impactful, fresh vegetable-based inclusions within a dough of a snack food product is typically avoided because of certain side-effects that manifest during the formulation of the snack food product. In particular, incorporating vegetable particles into a sheeted dough having a different texture can result in tearing of the dough, and the dehydration process, which usually includes baking and/or frying, tends to cause undesirable discoloration in the fruit and/or vegetable inclusions and the snack product itself.

### SUMMARY OF THE INVENTION

The present disclosure describes a shelf-stable with visibly impactful vegetable and/or fruit inclusions therein, a dough for forming the snack product, and a method of manufacture that preserves the native coloring of the fruit and/or vegetable inclusions. Although aspects of the disclosure concern to the inclusion of fresh, green, savory fruit and/or vegetable inclusions—such as peppers, spinach, cilantro, pea, and basil—for simplicity these inclusions will be referred to herein collectively as “vegetable inclusions.” Botanically, certain of these inclusions are derived from fruits; however, from a culinary standpoint these inclusions are considered vegetables.

Thus, in a first embodiment, inventors disclose a shelf-stable snack product formed from masa and a fresh vegetable ingredient. The fresh vegetable ingredient is cut into a plurality of pieces such that the resultant vegetable inclusions are visibly impactful, and are specially processed to retain its original coloring. The snack product should have a final moisture content in the range of about 1.7-2.5%, and in one aspect of this first embodiment, the snack product is a savory tortilla chip with an l-value no less than a corresponding l-value of a plain version of the snack product lacking the fresh vegetable ingredient. However, in another aspect of this embodiment, the snack product may be sweet product with vegetable inclusions.

In another embodiment, inventors disclose a composite dough for making a shelf-stable snack product with visibly impactful vegetable inclusions therein. The composite dough has a moisture content of about 50%, and is formed from a mixture of masa with a first moisture content of about 42-46% and a fresh vegetable ingredient with a second moisture content in the range of about 85-95%. The composite dough may include an optional amount of water added to achieve the 50% moisture content. Further, the composition of the composite dough may include the masa in a range of about 85-95% by weight, and the fresh vegetable ingredient in a range of about 5-15% by weight.

In another embodiment, inventors disclose a method for making the shelf-stable snack product with visibly impactful vegetable inclusions therein. The method includes the step of mixing a masa having a first moisture content of about 42-46% with a fresh vegetable ingredient having a second moisture content of about 85-95%. An optional amount of added water may also be mixed with the masa and the fresh vegetable ingredient to form a composite dough having a third moisture content of about 50%. The composite dough may include a mixture of the masa in a range of about 85-95% by weight and the fresh vegetable ingredient in a range of about 5-15% by weight. The composite dough may then be formed into a set of snack-sized pieces and partially dried to a moisture content of about 27-30%. Thereafter, the partially dried snack-sized pieces are cooked to a final moisture content of about 1.7-2.5% to form a shelf-stable snack product. The shelf-stable snack product has visibly impactful vegetable inclusions and an l-value no less than a corresponding l-value of a plain version of the snack product lacking the fresh vegetable ingredient.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flowchart of a process for producing a shelf-stable snack product having vegetable inclusions with preserved visuals.

FIG. 2 is a flowchart of a process for preparing corn masa and jalapeno peppers for use in the process of FIG. 1 to create a savory corn tortilla chip with jalapeno inclusions in accordance with an illustrative embodiment.

FIG. 3 is a snack product having a visibly impactful, vibrantly colored, fresh vegetable ingredient in accordance with an illustrative embodiment.

### DETAILED DESCRIPTION

In addition to taste, consumers may consider one or more other factors in the purchase of a snack product. These other factors may include texture, nutritional content, perception, and visual appeal. For example, a consumer may be swayed to purchase one type of snack product over another because the snack product is perceived as fresher and/or more nutritious. This perception can be conveyed to the consumer based upon factors such as ingredient type and presentation of the ingredient. A visibly impactful, vibrantly colored, fresh vegetable ingredient in a savory snack product may reinforce the perception of freshness and nutritiousness. However, traditional processing techniques have prevented the incorporation of fresh vegetables.

As used herein, when the term “visibly impactful” is used to describe vegetable inclusions within a snack product, such as a tortilla chip, the term means that the snack product includes vegetable inclusions that range in size from 1 to 4 millimeters, and more specifically anywhere from 2-12 vegetable inclusions greater than 2 mm in length, and between 17-43 inclusions less than 2 mm in length, but that the snack product has, on average, about 4 vegetable pieces that are about 2 mm in length. Also, as used herein, the term “fresh” when used to describe a vegetable ingredient means a vegetable that has not been dried or otherwise dehydrated at the time the ingredient was added to the snack product. These fresh vegetables may take one of three predominant forms: unpreserved, frozen, or brined. Unpreserved vegetables are harvested, minimally process, and then incorporated into a snack product without intermediate preservation steps. The most significant drawback associated with this type of fresh vegetable ingredient is the relatively short amount of time between the time of harvest to the time that the vegetable must be used to prevent it from wilting or spoiling. Frozen vegetables are a second form of fresh vegetable that can be incorporated into a snack product. After a vegetable is harvested, it may be processed (e.g., cut into an appropriate size, commonly between ⅛-¼ of an inch) then frozen. These types of fresh vegetable ingredient is generally termed an individually quick frozen (IQF) vegetable. Essentially, these frozen vegetable pieces may be stored almost indefinitely for use whenever convenient. The last form of fresh vegetable is brined. Brined vegetables may be optionally processed after harvest then stored in a brine solution. Brined ingredients may be stored almost indefinitely at ambient conditions. Although any one of these fresh vegetable forms may be used in the creation of a snack product, the use of either IQF vegetables or the brined vegetables provides increased manufacturing flexibility as the vegetable ingredient can be stored in a preserved state after harvest for a significant amount of time before the ingredient is used. In contrast, freshly harvested vegetables should generally be used shortly after harvest, sometimes within 24 hours, to obviate any food safety concerns.

In each embodiment, the color of the fresh vegetable ingredient is green, a characteristic that is imparted by the presence of chlorophyll. When incorporated into a snack product formed from a process having a thermal dehydration process, such as baking or frying, these fresh vegetables do not retain their native, green coloring because heat promotes the replacement of magnesium cations in chlorophyll with protons that change the pigment color to brown. Furthermore, mixing operations often cause juices from the fresh vegetable inclusions to seep out into the dough. Because the juices carry chlorophyll from the vegetable to the dough, subsequent cooking causes the dough to darken undesirably. Consequently, fresh vegetables having chlorophyll are not typically used in the manufacture of shelf-stable snack products, like tortilla chips. As already mentioned, seasonings were sometimes applied to give the snack product a fresher taste, but the seasonings are not visibly impactful and does not provide the same level of aesthetic benefit. Alternatively, previously dried inclusions may be substituted. However, the dried inclusions lacked the fresh taste and visual appeal that inventors hoped to achieve. In response inventors have devised a novel method for incorporating a fresh vegetable ingredient that is visibly impactful, while preserving the native coloring of the inclusions as described below.

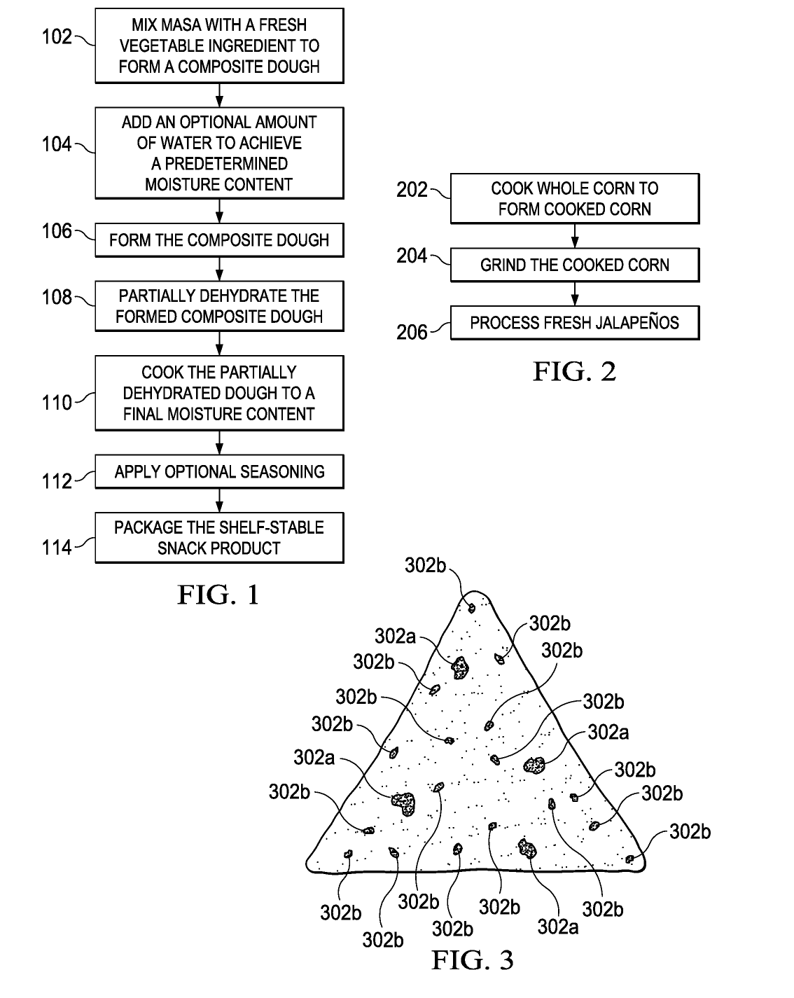

FIG. 1 is a flowchart of a method for producing a shelf-stable snack product having visibly impactful vegetable inclusions in accordance with an illustrative embodiment. Masa with a moisture content in the range of 42-46% is mixed with a fresh vegetable ingredient having a moisture content in the range of about 85-95% to form a composite dough (step 102). Percentages referenced throughout the disclosure shall refer to weight percentages unless a different designation is specifically provided. The composite dough is an intermediate dough-based product formed from masa and vegetable inclusions, which can be transformed into the final shelf-stable snack product after a dehydration and a cooking step.

An optional amount of water is added to obtain a composite dough having a moisture content of about 50% (step 104). The additional water may be added contemporaneously in the mixing step with the masa and the fresh vegetable ingredient if it can be determined that the mixture of the masa and the fresh vegetable ingredient will not yield a composite dough having the desired moisture content. Those having ordinary skill in the art would recognize that the added water may be added to either the masa or the fresh vegetable ingredient before step 102 to achieve the requisite moisture content of the composite dough. For example, if the masa is corn-based with a moisture content in the range of 10-15%, then in one embodiment, the added water may be added to the corn-based masa before mixing with the fresh vegetable ingredient to facilitate the mixing of the fresh vegetable ingredient into the masa.

However, it was observed that the moisture content of the masa is proportionate to the amount of mixing required to fully integrate and distribute the fresh vegetable ingredient throughout the masa. In particular, a higher moisture content required less mixing whereas a lower moisture content required relatively more mixing. The amount of mixing is in turn proportionate to the amount of juice that seeps out of the vegetable inclusions into the masa. Because the vegetable juices contain chlorophyll, limiting the amount of juice seepage into the composite dough reduces the presence of chlorophyll, which reduces browning of the chip during thermal dehydration. As a result, a lighter colored chip may be attained during the cooking process. Thus, in one embodiment, the additional water is added and mixed into the masa before mixing in the vegetable inclusions.

The mixing step may be performed in any currently known or later developed mixing apparatus. In the exemplary method described herein, the masa and vegetable inclusions were mixed in a collection feeder of a standard tortilla chip production apparatus. The collection feeder includes two paddles rotating at about 40 RPM and the masa and vegetable inclusions were dosed at a steady rate.

The optional step of 104 of adding additional water may be skipped if the mixture of the fresh vegetable ingredient and the masa would produce a composite dough with a moisture content in the proper range. For example, in some instances, the fresh vegetable ingredient may be provided as an IQF or brined vegetable having sufficient moisture that could obviate the need to add the additional water in step 104.

Once the moisture content of the composite dough has been attained, the dough may be formed (step 106). The forming step shapes the dough into the snack piece that can then be cooked. If the end product is a chip, then the forming step may include the steps of sheeting the dough, then cutting the dough into a set of snack pieces.

The formed dough is then partially dehydrated (step 108). In a particular embodiment, this partial dehydration step takes place in an oven where the formed dough pieces are exposed to a temperature in the range of 450-600 degrees Fahrenheit (232-315 degrees Celsius) for a dwell time of about 30 seconds. After this partial dehydration step, the partially dehydrated dough pieces have a moisture content in the range of about 27-30%.

The partially dehydrated snack pieces are further cooked to achieve the final moisture content in the range of 1.7-2.5% (step 110). In a non-limiting embodiment, this further cooking step is performed in a fryer with oil maintained at a temperature in the range of 350-365 degrees Fahrenheit (176-185 degrees Celsius) for a dwell time of approximately 90 seconds.

The fried snack pieces may then be optionally seasoned (step 112). In a non-limiting embodiment, the seasoning may include salt and/or pepper. After seasoning, the fried snack pieces are packaged for delivery (step 114).

The intermediate dehydration step 108 before the further cooking step 110 creates a structurally sound intermediate product with the desired characteristic blisters found in tortilla chips, which can then be fried. In the event that blistering of the final snack product is to be reduced or eliminated, then the intermediate dehydration step 108 may be bypassed and the formed snack product from step 106 may be introduced directly to the cooking step 110.

FIG. 2 is a flowchart of a process for creating the masa and fresh vegetable ingredient for use in the process described in FIG. 1. In this illustrative example, the masa is formed from corn and the fresh vegetable ingredient is jalapeno, and the finished snack product is a corn tortilla chip with jalapeno inclusions having visually apparent vegetable pieces with preserved color attributes.

In a first step, whole corn is cooked to form cooked corn (step 202). In a non-limiting embodiment, the corn is cooked in accordance with a traditional nixtamalization process in which the corn is cooked with lime, soaked for 12 hours, then washed to remove the lime. The cooked corn may then be ground to form the masa (step 204). In one embodiment of the cooked corn is ground in a grinder having a gap of about 0.023 inches separating the grinding surfaces to produce a relatively coarser grind than is traditionally used for creating corn tortilla chips. Fresh jalapenos are then processed to obtain the fresh vegetable ingredient with the desired particle size (step 206). The type of processing is determined based upon the type of fresh jalapenos that are being used. If the fresh jalapenos are IQF jalapenos, then the process may include breaking up the block of frozen jalapenos, further cutting the vegetable pieces to reduce the size from the commercially available size between ⅛-¼ inches (3.175-6.35 mm) to a size between 3/100- 16/100 inches (1-4 mm). Sheeting a dough with inclusions of commercially available sizes would result in excessive tearing. Accordingly, the jalapenos are further cut with a cutting apparatus having parallel blades with a gap width of 1/12- 1/16 inches (2.11-1.6 mm). If the fresh jalapenos are provided in a brined solution, then the processing step 206 may include an optional draining step and a cutting step to reduce the size of the jalapeno pieces with the same parallel blades having a gap width of 1/12- 1/16 inches (2.11-1.6 mm). These ingredients are then introduced into the process described in FIG. 1, beginning at step 102.

Table 1 provides a list of ingredients, along with their relative amounts and approximate moisture contents, for use in creating the corn tortilla snack product formulated according to the steps of the FIG. 2, described above.

TABLE 1

| Composite Dough | | |
|---|---|---|
| Ingredient | Weight % | Moisture (g/100 g) |
| Milled Corn | 85-95 | 42-46 |
| Jalapenos (frozen or | 5-15 | 85-95 |
| brined) | | |
| Added Water | 1-2 | 100 |

In the event that the jalapenos are brined, they may be stored in glacial acetic acid that is 3 weight percent acetic acid and 12-14 weight percent salt. Alternatively, the brined jalapenos may be stored in a vinegar solution that is 50 weight percent vinegar and 12 weight percent salt.

The snack product, a dough for creating the snack product, and corresponding method of manufacture provides a shelf-stable snack product created to satisfy consumer preferences regarding taste, texture, and visual appeal. As an added benefit, when the snack product is a corn tortilla chip, the snack product retains the visual characteristics of the existing snack product that consumers have grown accustomed to eating. In particular, the novel processing methods allowed the creation of a corn tortilla chip with an overall lightness value (hereinafter “l-value”) no less than the l-value of a plain tortilla chip lacking vegetable inclusions. A lightness value is a relative term that describes an object's brightness in comparison to a reference area that is white and similarly illuminated. Higher l-values correspond with paler, lighter-colored products. In particular, the lightness value of the shelf-stable corn tortilla chip with visibly impactful, fresh vegetable inclusions was determined to be 61.5 using a Hunter Color Measurement. Importantly, l-values greater than or equal to 60 were determined to yield a tortilla chip product having a color that is similar to plain corn tortilla chip lacking vegetable inclusions.

Although the particular example disclosed above relates to the creation of a tortilla chip with fresh vegetable inclusions which has an l-value that is no less than a corresponding l-value of a plain tortilla chip that lacks the fresh vegetable inclusion, novel aspects of this disclosure may be applied to other food items to achieve a product that includes visibly impactful, fresh vegetable inclusions, and a food item that has an l-value no less than a corresponding l-value of a plain version of that food item that lacks vegetable inclusions.

FIG. 3 is a snack product with a visibly impactful, vibrantly colored, fresh vegetable inclusions in accordance with an illustrative embodiment. In this non-limiting embodiment, the snack product is a corn tortilla chip with fresh jalapeno inclusions formed by the process set forth in FIGS. 1 and 2, above. Tortilla chip 300 is depicted in FIG. 3 as having a triangular shape; however, in alternate embodiments, tortilla chip 300 may be formed into any number of shapes including, but not limited to, a rectangle or circle. Tortilla chip 300 includes a set of vegetable inclusions 302 formed from, on average, about four vegetable inclusions that are at least 2 mm in length, identified by reference numeral 302a. Smaller vegetable inclusions less than 2 mm in length are identified by reference numeral 302b. The length of the vegetable inclusion is the greatest length that separates two different points on a perimeter of the vegetable inclusion. Thus, the length of a vegetable inclusion can be measured along an edge, or from two points on the perimeter of the vegetable inclusion which are generally located on opposite sides of the vegetable inclusion. For example, if the vegetable inclusion is generally circular, the length of the vegetable inclusion is the diameter. Further, the set of vegetable inclusions 302 are generally interspersed evenly throughout tortilla chip 300, which is indicative of a thorough mixing of masa and vegetable inclusions in step 102 of FIG. 1, but without excessive mixing that would otherwise result in a tortilla chip having an undesirable l-value less than that of a plain tortilla chip lacking vegetable inclusions.

While this invention has been particularly shown and described with reference to certain embodiments, it will be understood by those skilled in the art that various changes in form and detail may be made therein without departing from the spirit and scope of the invention. For example, although the disclosure described the incorporation of fresh-vegetable inclusions in a savory snack, such as a corn tortilla chip, the inventive concepts provided herein may be applied to other forms of snacks, such as sweet snacks having a sweet and spicy taste profile. Further, illustrative examples provided herein described a fresh jalapeno ingredient; however, alternate embodiments may also contemplate the use of serranos and green peppers. Accordingly, the inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### Additional Description

In a first embodiment, the disclosure describes a shelf-stable snack product having visibly impactful vegetable inclusions. The shelf-stable snack product is formed from masa and a fresh vegetable ingredient. In addition, the shelf-stable snack product has a final moisture content in the range of 1.7-2.5 weight percent and an l-value no less than a corresponding l-value of a plain version of the shelf-stable snack product lacking the fresh vegetable ingredient.

Another embodiment including any one or more of the elements in a previous embodiment disclosed above, wherein the shelf-stable snack is formed from a composite dough comprising between 85-95 weight percent of the masa and between 5-15 weight percent of the fresh vegetable ingredient.

Another embodiment including any one or more of the elements in a previous embodiment disclosed above, wherein each of a plurality of pieces of the shelf-stable snack product comprises 2-12 vegetable inclusions greater than 2 mm in length, and between 17-43 inclusions less than 2 mm in length.

Another embodiment including any one or more of the elements in a previous embodiment disclosed above, wherein the masa comprises ground corn.

Another embodiment including any one or more of the elements in a previous embodiment disclosed above, wherein the shelf-stable snack product is a corn tortilla chip, and wherein the l-value is greater than or equal to 60.

Another embodiment including any one or more of the elements in a previous embodiment disclosed above, wherein the fresh vegetable ingredient is jalapeno.

Another embodiment including any one or more of the elements in a previous embodiment disclosed above, wherein the shelf-stable snack product further includes seasoning.

Another embodiment including any one or more of the elements in a previous embodiment disclosed above, wherein the seasoning is at least one of salt and pepper.

Another embodiment including any one or more of the elements in a previous embodiment disclosed above, wherein the fresh vegetable ingredient is brined, and wherein the fresh vegetable ingredient further comprises 50 weight percent vinegar and 12 weight percent salt.

Another embodiment including any one or more of the elements in a previous embodiment disclosed above, wherein fresh vegetable ingredient is brined, and wherein the fresh vegetable ingredient further comprises 3 weight percent acetic acid and between 12-14 weight percent salt.

Another embodiment including any one or more of the elements in a previous embodiment disclosed above, wherein the fresh vegetable ingredient ranges in size from 1 to 4 mm.

In a second aspect, the disclosure describes a composite dough for forming a shelf-stable snack product with a final moisture content between 1.7-2.5 weight percent, and the composite dough having a third moisture content of about 50 weight percent. The composite dough includes masa with a first moisture content of about 42-46 weight percent, and a fresh vegetable ingredient with a second moisture content between 85-95 weight percent. The composite dough may include an optional amount of water to achieve the third moisture content. Further, the masa comprises about 85-95 weight percent of the composite dough, and the fresh vegetables comprise about 5-15 weight percent of the composite dough.

Another embodiment including any one or more of the elements in a previous embodiment disclosed above, wherein the fresh vegetable ingredient is jalapeno.

Another embodiment including any one or more of the elements in a previous embodiment disclosed above, wherein the jalapeno is between 1-4 mm.

In a third aspect, the disclosure describes a method for creating a shelf-stable snack product with preserved inclusions, the method including the steps of mixing masa having a first moisture content of about 42-46 weight percent with a fresh vegetable ingredient having a second moisture content of about 85-95 weight percent, and an optional amount of added water to form a composite dough having a third moisture content of about 50 weight percent. The masa comprises about 85-95 weight percent of the composite dough, and the fresh vegetable ingredient comprises about 5-15 weight percent of the composite dough. The composite dough is formed into a set of snack-sized dough pieces, and then the set of snack-sized dough pieces are partially dehydrated to form partially dried snack pieces having a fourth moisture content of about 27-30 weight percent. The partially dehydrated snack pieces are cooked to form cooked snack pieces having a final moisture content of about 1.7-2.5 weight percent. The cooked snack pieces have an l-value greater than 60.

Another embodiment including any one or more of the elements in a previous embodiment disclosed above, wherein whole corn is cooked to form cooked corn, and then the cooked corn is ground to form the masa.

Another embodiment including any one or more of the elements in a previous embodiment disclosed above, wherein the forming step further includes the steps of rolling the composite dough to form a composite dough sheet, and cutting the composite dough sheet into the set of snack-sized dough pieces.

Another embodiment including any one or more of the elements in a previous embodiment disclosed above, further including the steps of seasoning the cooked snack pieces, and packaging the plurality of cooked snack pieces.

Another embodiment including any one or more of the elements in a previous embodiment disclosed above, including the step of baking the set of snack-sized dough pieces in an oven at a temperature between 450-600 degrees Fahrenheit for a dwell time of about 30 seconds.

Another embodiment including any one or more of the elements in a previous embodiment disclosed above, including the step of frying the partially dried snack product at a temperature of about 350-365 degrees Fahrenheit for a dwell time of about 90 seconds.

We claim:

1. A shelf-stable snack product having visibly impactful vegetable inclusions, comprising:
masa; and
a fresh vegetable ingredient;
wherein the shelf-stable snack product comprises a final moisture content of about 1.7-2.5 weight percent;
and wherein the shelf-stable snack product comprises an l-value that is no less than a corresponding l-value of a plain version of the shelf-stable snack product lacking the fresh vegetable ingredient.

2. The shelf-stable snack product according to claim 1, wherein the shelf-stable snack is formed from a composite dough comprising between 85-95 weight percent of the masa and between 5-15 weight percent of the fresh vegetable ingredient.

3. The shelf-stable snack product according to claim 1, wherein each of a plurality of pieces of the shelf-stable snack product comprises 2-12 vegetable inclusions greater than 2 mm in length, and between 17-43 inclusions less than 2 mm in length.

4. The shelf-stable snack product according to claim 1, wherein the masa comprises ground corn.

5. The shelf-stable snack product according to claim 4, wherein the shelf-stable snack product is a corn tortilla chip, and wherein the l-value is greater than or equal to 60.

6. The shelf-stable snack product according to claim 1, wherein the fresh vegetable ingredient is jalapeno.

7. The shelf-stable snack product according to claim 1, further comprising seasoning.

8. The savory snack product according to claim 7, wherein the seasoning comprises at least one of salt and pepper.

9. The shelf-stable snack product according to claim 1, wherein the fresh vegetable ingredient is brined, and wherein the fresh vegetable ingredient further comprises 50 weight percent vinegar and 12 weight percent salt.

10. The shelf-stable snack product according to claim 1, wherein the fresh vegetable ingredient is brined, and wherein the fresh vegetable ingredient further comprises 3 weight percent acetic acid and between 12-14 weight percent salt.

11. The shelf-stable snack product according to claim 1, wherein the fresh vegetable ingredient ranges in size from 1 to 4 mm.

12. A composite dough for forming a shelf-stable snack product with a final moisture content between 1.7-2.5 weight percent, the composite dough having a third moisture content of about 50 weight percent, the composite dough comprising:
masa with a first moisture content of about 42-46 weight percent;
a fresh vegetable ingredient with a second moisture content between 85-95 weight percent; and
an optional amount of water to achieve the third moisture content;
wherein the masa comprises about 85-95 weight percent of the composite dough, and wherein the fresh vegetables comprise about 5-15 weight percent of the composite dough.

13. The composite dough according to claim 12, wherein the fresh vegetable ingredient is jalapeno.

14. The composite dough according to claim 13, wherein the jalapeno is between 1-4 mm.

15. A method for creating a shelf-stable snack product with vegetable inclusions, the method comprising:
mixing masa having a first moisture content of about 42-46 weight percent with a fresh vegetable ingredient having a second moisture content of about 85-95 weight percent, and an optional amount of added water to form a composite dough having a third moisture content of about 50 weight percent, wherein the masa comprises about 85-95 weight percent of the composite dough, and wherein the fresh vegetable ingredient comprises about 5-15 weight percent of the composite dough;
forming the composite dough into a set of snack-sized dough pieces;
partially dehydrating the set of snack-sized dough pieces to form partially dried snack pieces having a fourth moisture content of about 27-30 weight percent; and
cooking the partially dried snack pieces to form cooked snack pieces having a final moisture content of about 1.7-2.5 weight percent.

16. The method of claim 15, further comprising:
cooking whole corn to form cooked corn; and
grinding the cooked corn to form the masa.

17. The method of claim 15, wherein the forming step further comprising:
rolling the composite dough to form a dough sheet; and
cutting the dough sheet into the set of snack-sized dough pieces.

18. The method of claim 15, further comprising:
seasoning the cooked snack pieces; and
packaging the plurality of cooked snack pieces.

19. The method of claim 15, wherein the partial dehydration step further comprises:
baking the set of snack-sized dough pieces in an oven at a temperature between 450-600 degrees Fahrenheit for a dwell time of about 30 seconds.

20. The method of claim 15, wherein the cooking step further comprises frying the partially dried snack product at a temperature of about 350-365 degrees Fahrenheit for a dwell time of about 90 seconds.
